(19) United States
(12) Patent Application Publication
(10) Pub. No.: US 2017/0284943 A1
(43) Pub. Date: Oct. 5, 2017

(54) DETECTING VOIDS AND DELAMINATION IN PHOTORESIST LAYER

(71) Applicants: Nilanjan Ghosh, Chandler, AZ (US); Deepak Goyal, Phoenix, AZ (US); Jing Cheng, Chandler, AZ (US); Leonel R. Arana, Phoenix, AZ (US)

(72) Inventors: Nilanjan Ghosh, Chandler, AZ (US); Deepak Goyal, Phoenix, AZ (US); Jing Cheng, Chandler, AZ (US); Leonel R. Arana, Phoenix, AZ (US)

(21) Appl. No.: 15/083,883

(22) Filed: Mar. 29, 2016

(51) Int. Cl. G01N 21/95; G01N 21/55

(52) U.S. Cl. CPC G01N 21/95; G01N 21/55; G01N 2201/13; G01N 2201/0612

(57) ABSTRACT

A system for detecting a void in a photoresist layer can include: a detector, a processor, and a memory. The detector can be arranged to receive reflected light from a surface of a sample. The processor can be in electrical communication with the detector, The memory can store instructions that, when executed by the processor, can cause the processor to perform operations. The operations can comprise: receiving optical data from the detector, receiving calibrated data, and determining an existence of the void. the optical data can include information regarding a signature of the reflected light. The calibrated data can include information regarding a signature for a known sample of photoresist. The determination of the existence of the void can be based on a deviation of the optical data from the calibrated data.

### TECHNICAL FIELD

Embodiments described generally herein relate to detecting voids and delamination in a surface layer. Some embodiments relate to detecting voids and delamination in a photoresist layer applied to a substrate.

### BACKGROUND

Photoresist is a light-sensitive material used in manufacturing printed circuit boards and other electronic devices. Photoresists are generally classified as positive resist or negative resist. A positive photoresist is a material that when exposed to light becomes soluble to a photoresist developer. A negative photoresist is a material that when exposed to light becomes insoluble to a photoresist developer.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a schematic of a sample showing voids and delamination in accordance with some embodiments.

FIG. 2 illustrates an example manufacturing method in accordance with some embodiments.

FIG. 3 illustrates an example system for detecting voids and delamination in accordance with some embodiments.

FIG. 4 illustrates an example sample with a void in accordance with some embodiments.

FIG, 5 illustrates an example schematic of a computing device in accordance with some embodiments.

FIG. 6 illustrates an example method for detecting voids and delamination in accordance with some embodiments.

### DETAILED DESCRIPTION

During a manufacturing process, voids and delamination under photoresist thin-films can develop. The voids and delamination can range in size from about 1μm and about 80 μm. The voids and delamination can result in yield loss during a substrate process development. The yield loss can be due to downstream processing of panels with voids and delamination resulting in plating under the photoresist. The plating under the photoresist can cause shorting of metal traces leading to electrical failures.

The systems and methods disclosed herein can provide monitoring techniques to detect voids and delamination. As disclosed herein, infrared imaging can be used to visualize the voids and delamination. In addition, a tunable wavelength imaging device can be utilized. As a result, the systems and methods disclosed herein can be material independent. Stated another way, the systems and methods disclosed herein can allow for imaging through thin film layers. Examples thin film layers include, but are not limited to, organic layer, dry film photoresist, dielectrics, and solder resist,

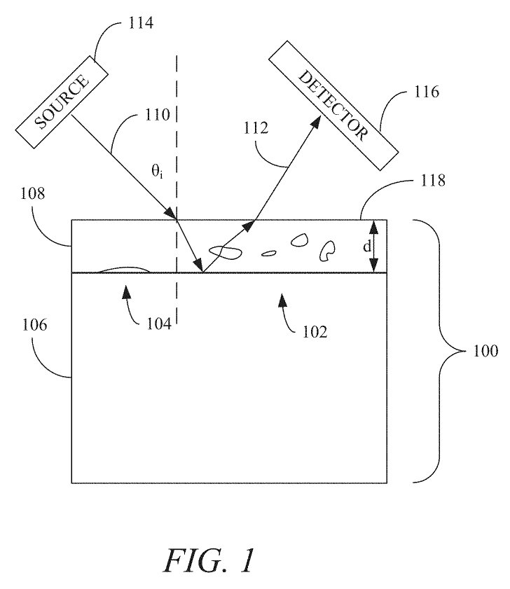

FIG. 1 illustrates a schematic of a sample 100 with voids 102 and delamination 104. The sample 100 can include a substrate 106 having a photoresist layer 108. As shown in FIG. 1, an incident light 110 can interact with a surface 118 of the sample 100. The incident light 110 can pass through the photoresist layer 108 and become reflected light 112. Both the incident light 110 and the reflected light 112 can experience different levels of refraction due to passing through the voids 102 and delamination 104.

As shown in FIG. 1, the incident light 110 can emanate from a source 114 and the reflected light 112 can be collected by a detector 116. The incident light 110 can have constant properties or variable properties. For example, the incident light 110 can have a constant wavelength or a variable wavelength. For instance, the incident light 110 can have a wavelength that varies between about 1 μm to about 20 μm. A non-limiting example of the source 114 can be a tunable laser, such as a tunable quantum cascade laser. The detector 116 can include wavelength independent optics. For example, because the wavelength of the incident light 110 can vary, the optics can include zinc-selenium (Zn—Se) optics to allow for use over a wide range of wavelengths.

The detector 116 can measure different properties of the reflected light 112. For example, the detector 116 can measure the wavelength, brightness, irradiance, and intensity of the reflected light 112. The measurements made by the detector 116 can be used to create a signature for the reflected light 112. As discussed herein, the signature created using data collected from the detector 116 can be compared to known signatures to determine existence of the voids 102 and delamination 104. For example, intensity measurements can be made for a sample of a photoresist material having a thickness, d, applied to a substrate (e.g., copper) without any voids or delamination. The intensity measurements can be used to create a signature for the sample.

To detect voids 102 or delamination 104, intensity data can be captured for sample 100. The two signatures can then be compared and any differences can indicate the voids 102, delamination 104, or other defects. The differences can also be subject to a prescribed error in order to indicate a potential defect. For instance, in order for a difference to be considered a potential defect, the measured intensity for the sample 100 may need to be greater than X percent of the baseline intensity.

As shown in FIG. 1, the source 114, can direct the incident light 110 at the surface 118 at an angle, θᵢ, and the detector 116 can collect reflected light 112. In addition, the source 114 can utilize various lenses or filters to produce a desire desired wavelengths, polarization, etc. The detector 116, or other computing device in electrical communication with the detector 116, can determine a wavelength, intensity, irradiance, etc. of the reflected light 112.

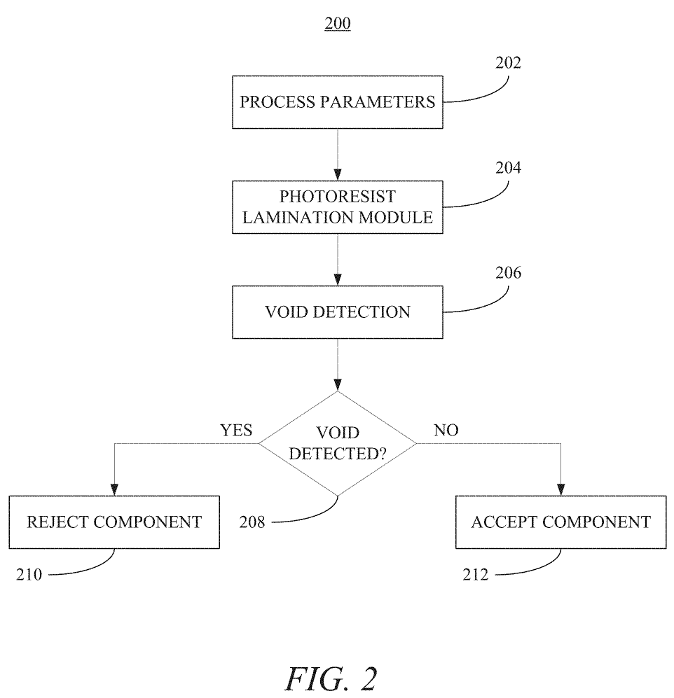

FIG. 2 illustrates a method 200 for a process for manufacturing printed circuit boards, processor chips, etc. in accordance with embodiments disclosed herein. The method 200 can begin at stage 202 where processing parameters can be defined. For example, parameters such as, but not limited to, photoresist material properties, thickness, substrate properties, irradiance patterns, reflection patterns, etc.

From stage 202, the method 200 can proceed to stage 204 where the photoresist material can be applied to a substrate. For example, a positive or negative photoresist material can be applied to a copper substrate. The photoresist material can have a given thickness and can be applied at a preset application rate.

From stage 204, the method 200 can proceed to stage 206 where voids and delamination can be detected. For instance, as described herein the source 114 can direct the incident light 110 at the sample 100 and the detector 116 can collect the reflected light 112. Using the reflected light 112 and the process parameters from stage 202 the voids and delamination can be detected.

From stage 206, the method 200 can proceed to decision block 208, where a determination can be made as to if voids or a delamination have been detected. If voids or delamination are detected, the method 200 can proceed to stage 210 where the component can be rejected. If void or delamination are not detected, the method 200 can proceed to stage 212 where the component can be accepted and sent for further processing.

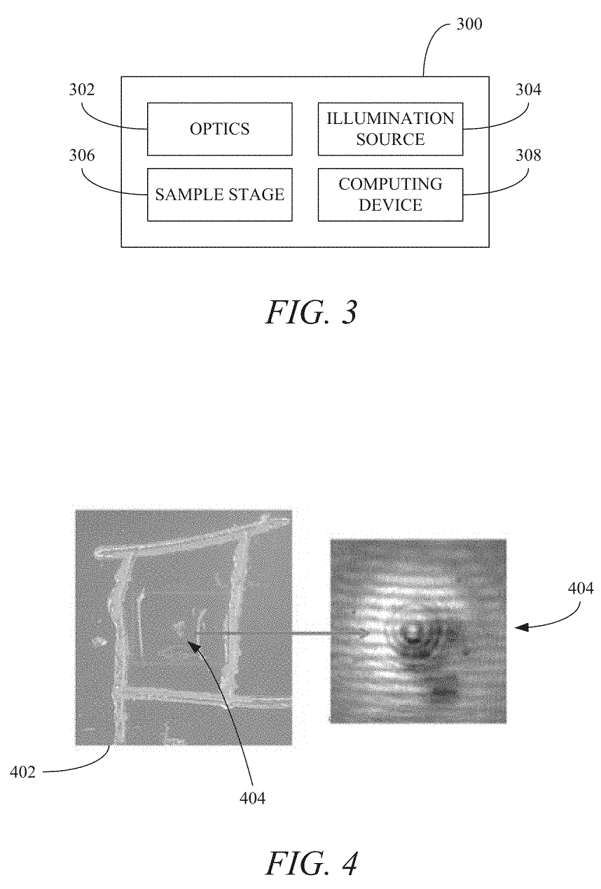

FIG. 3 illustrates a system 300 for detecting voids and delamination. The system 300 can include detection optics 302, an illumination source 304, a sample stage 306, and a computing device 308. As described herein, the detection optics 302 can include Zn—Se based optics used in the detector 116. In addition, the detection optics 302 can be wavelength independent to allow for a variety of wavelengths to be used for collecting data regarding the sample (e.g., sample 100).

The illumination source 304 can include the source 114 in addition to optics that can be used to control the incident light 110. For example, the illumination source 304 can be a tunable laser to allow for controlling of the wavelength of the incident light 110. In addition, the illumination source 304 can include lenses, filters, and polarizers to further control the incident light 110.

The sample stage 306 can be a component of an assembly line. For example, the sample stage 306 can be a portion of a track carrying components. As the components progress along the track, the illumination source 304 can direct the incident light 110 onto the components and the detection optics 302 can collect the reflected light 112. The computing device 308 is described below with reference to FIG. 5.

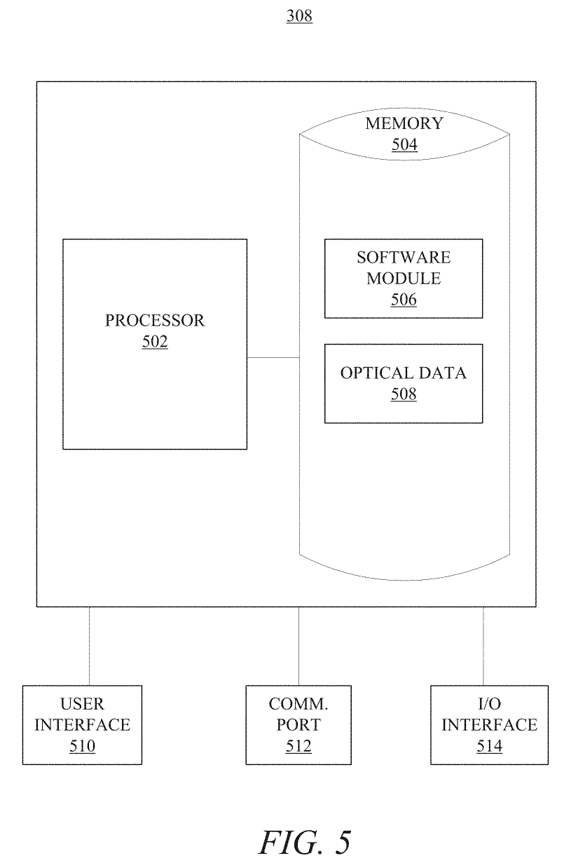

FIG. 4 shows an example sample 402 with a void 404. The void 404, as shown in FIG. 4, has a size of approximately 20 μm underneath a 25 μm dry film photoresist (DFR) film located on a copper substrate. The void 404 was detected using a tunable near/mid infrared imaging system as described herein. The void 404 was generated during the photo-resist lamination process; such as stage 204 described above with regards to FIG. 2.

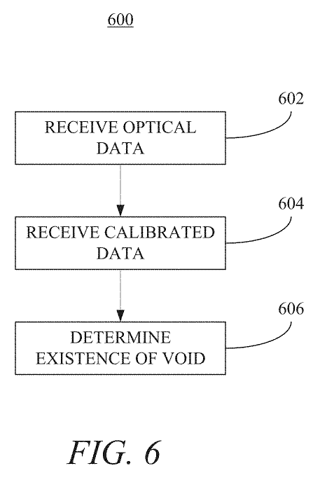

FIG. 5 illustrates an example schematic of a computing device 308. As shown in FIG. 5, computing device 308 may include a processor 502 and a memory unit 504. The memory unit 504 can include a software module 506 and optical data 508. While executing on the processor 502, the software module 506 can perform processes for detecting voids and delamination, including, for example, one or more stages included in method 600 described below with respect to FIG. 6.

Optical data 508 can include the wavelength, frequency, incident angle, polarization change, refractive index, extinction coefficient, irradiance, brightness, reflectance, intensity, etc. as described herein. The computing device 308 can also include a user interface 51_0. The user interface 510 can include any number of devices that allow a user to interface with the computing device 308. Non-limiting examples of the user interface 510 can include a keypad, a microphone, a speaker, a display (touchscreen or otherwise), etc.

The computing device 308 may also include a communications port 512. The communications port 512 can allow the computing device 308 to communicate with other computing devices and testing instrumentation such as spectrometers, the illumination source 304, and the detection optics 302. Non-limiting examples of the communications port 812 can include, Ethernet cards (wireless or wired), serial ports, parallel ports, etc.

The computing device 308 can also include an input/output (110) device 514. The I/O device 514 can allow the computing device 308 to receive and output information. Non-limiting examples of the 110 device 514 can include, a camera (still or video), a printer, a scanner, etc.

The computing device 308 can be implemented using a personal computer, a network computer, a mainframe, a handheld device, a personal digital assistant, a smartphone, or any other similar microcomputer-based workstation. The computing device 308 can be a standalone device or can be combined with another device. For example, the computing device 308 may be a desktop computer used by a user that is connect to a spectrometer or other components of system 300. In addition, the computing device 308 can be integrated into a spectrometer or any of the components of system 300. In this instance, the computing device 308 can also include software, stored in the software module 506, that can control the detection optics 302, the illumination source 304, and the sample stage 306 used to collect data as described herein.

FIG. 6 illustrates an example method 600 for detecting voids and delamination. The method 600 can begin at stage 602 where optical data can be received. For example, the computing device 308 can receive optical data from the detection optics 302. As discussed herein, the optical data can include wavelength, irradiance, intensity, etc. In addition, the computing device 308 can receive optical data from multiple locations on a sample. For instance, the incident light 110 can have a spot size of about 1 mm by 1 nun and the source 114 can be configured to direct the incident light 110 at various locations along the sample 100. The optical data from each of the locations can be used to detect voids and delamination at the various locations.

From stage 602, the method 600 can proceed to stage 604 where calibrated data can be received. For example, at stage 604 the computing device 308 can calibrated data corresponding to the photoresist material. For instance, the processor 502 can retrieve signatures that correspond to the photoresist material from the memory 504.

From stage 604, the method 600 can proceed to stage 606 where a determination can be made as to if voids or a delamination exist. For example, the optical data and the calibrated data can be images. At stage 606, the computing device 308 can perform an image analysis of the optical data and the calibrated data images to determine variances, if any, in the optical data and the calibrated data. The variances, can indicate a void or delamination.

The term “module” is understood to encompass a tangible entity, be that an entity that is physically constructed, specifically configured (e.g., hardwired), or temporarily (e.g., transitorily) configured (e.g., programmed) to operate in a specified manner or to perform at least part of any operation described herein. Considering examples in which modules are temporarily configured, a module need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. The term “application,” or variants thereof, is used expansively herein to include routines, program modules, programs, components, and the like, and may be implemented on various system configurations, including single-processor or multiprocessor systems, microprocessor-based electronics, single-core or multi-core systems, combinations thereof, and the like. Thus, the term application may be used to refer to an embodiment of software or to hardware arranged to perform at least part of any operation described herein.

While a machine-readable medium may include a single medium, the term “machine-readable medium” may include a single medium or multiple media (e.g., a centralized or distributed database, and/or associated caches and servers).

The term “machine-readable medium” may include any medium that is capable of storing, encoding, or carrying instructions for execution by a machine (e.g., the computing device 308 or any other module) and that cause the machine to perform any one or more of the techniques of the present disclosure, or that is capable of storing, encoding or carrying data structures used by or associated with such instructions. In other words, the processor 502 can include instructions and can therefore be termed a machine-readable medium in the context of various embodiments. Other non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium utilizing any one of a number of transfer protocols (e.g., frame relay, internet protocol (IP), TCP, user datagram protocol (UDP), hypertext transfer protocol (HTTP), etc.). Example communication networks may include a local area network (LAN), a wide area network (WAN), a packet data network (e.g., the Internet), mobile telephone networks ((e.g., channel access methods including Code Division Multiple Access (CDMA), Time-division multiple access (TDMA), Frequency-division multiple access (FDMA), and Orthogonal Frequency Division Multiple Access (OFDMA) and cellular networks such as Global System for Mobile Communications (GSM), Universal Mobile Telecommunications System (UMTS), CDMA 2000 1x* standards and Long Term Evolution (LTE)), Plain Old Telephone (POTS) networks, and wireless data networks (e.g., institute of Electrical and Electronics Engineers (IEEE) 802 family of standards including IEEE 802.11 standards (WiFi), IEEE 802.16 standards (WiMax®) and others), peer-to-peer (P2P) networks, or other protocols now known or later developed.

The tern “transmission medium” shall be taken to include any intangible medium that is capable of storing, encoding or carrying instructions for execution by hardware processing circuitry, and includes digital or analog communications signals or other intangible medium to facilitate communication of such software.

### ADDITIONAL NOTES & EXAMPLES

Example 1 includes a system for detecting a void in a photoresist layer. The can include: a detector, a processor, and a memory. The detector can be arranged to receive reflected light from a surface of a sample. The processor can be in electrical communication with the detector. The memory can store instructions that, when executed by the processor, can cause the processor to perform operations. The operations can comprise: receiving optical data from the detector, receiving calibrated data, and determining an existence of the void the optical data can include information regarding a signature of the reflected light. The calibrated data can include information regarding a signature for a known sample of photoresist. The determination of the existence of the void can be based on a deviation of the optical data from the calibrated data.

In Example 2, the system of Example 1, can optionally include a light source arranged to direct the incident light onto the surface of the sample.

In Example 3, the system of Example 2, can optionally include the light source including a tunable laser.

In Example 4, the system of any one of or any combination of Examples 1-3 can optionally include a wavelength of the reflected light is between about 1 μm and about 20 μm.

In Example 5, the system of any one of or any combination of Examples 1-3 can optionally include a wavelength of the reflected light is in the infrared spectrum.

in Example 6, the system of any one of or any combination of Examples 1-5 can optionally include an incident light has a spot size of about 1 mm by 1 mm.

In Example 7, the system of any one of or any combination of Examples 1-6 can optionally include the optical data including optical data for multiple locations on the surface of the sample.

In Example 8, the system of any one of or any combination of Examples 1-7 can optionally include the detector including Zn—Se based optics.

in Example 9, the system of any one of or any combination of Examples 1-8 can optionally include the signature of the reflected light including an intensity of the reflected light.

In Example 10, the system of any one of or any combination of Examples 1-8 can optionally include the signature of the reflected light including an irradiance of the reflected light.

In Example 11, the system of any one of or any combination of Examples 1-10 can optionally include the deviation including a contrast between a first image generated using the optical data and a second image generated using the calibrated data.

In Example 12, the system of any one of or any combination of Examples 1-11 can optionally include the sample being in motion when the reflected light is received at the detector.

Example 13 can include a method for detecting a void in a photoresist layer. The method can comprise: receiving optical data from a detector, receiving calibrated data, and determining an existence of the void. The optical data can include information regarding a signature of the reflected light. The calibrated data can include information regarding a signature for a known sample of photoresist. The determination of the existence of the void can be based on a deviation of the optical data from the calibrated data.

In Example 14, the method of Example 13 can optionally include utilizing a laser to direct an incident light onto the surface of the sample.

In Example 15, the method of Example 14 can optionally include the laser being a tunable laser.

In Example 16, the method of any one of or any combination of Examples 13-15 can optionally include a wavelength of the reflected light being between about 1 μm and about 20 μm.

In Example 17, the method of any one of or any combination of Examples 13-15 can optionally include a wavelength of the reflected light being in the infrared spectrum.

In Example 18, the method of any one of or any combination of Examples 13-17 can optionally include an incident light having a spot size of about 1 mm by 1 mm.

In Example 19, the method of any one of or any combination of Examples 13-18 can optionally include the optical data including optical data for multiple locations on the surface of the sample.

In Example 20, the method of any one of or any combination of Examples 13-19 can optionally include the detector including Zn—Se based optics.

In Example 21, the method of any one of or any combination of Examples 13-20 can optionally include the signature of the reflected light including an intensity of the reflected light.

In Example 22, the method of any one of or any combination of Examples 13-20 can optionally include the signature of the reflected light including an irradiance of the reflected light.

in Example 23, the method of any one of or any combination of Examples 13-22 can optionally include the deviation including a contrast between a first image generated using the optical data and a second image generated using the calibrated data.

In Example 24, the method of any one of or any combination of Examples 13-23 can optionally include the sample being in motion when the reflected light is received at the detector.

Example 25 can include a system for detecting a void in a photoresist layer. The system can comprise: means for receiving optical data from a detector, means for receiving calibrated data, and means for determining an existence of the void. The optical data can include information regarding a signature of the reflected light. The calibrated data can include information regarding a signature for a known sample of photoresist. The determination of the existence of the void can be based on a deviation of the optical data from the calibrated data.

In Example 26, the system of Example 25 can optionally include means for directing an incident light onto the surface of the sample.

in Example 27, the system of Example 25 can optionally include the means for directing the incident light including a tunable laser.

In Example 28, the system of any one of or any combination of Examples 25-27 can optionally include a wavelength of the reflected light being between about 1 μm and about 20 μm.

In Example 29, the system of any one of or any combination of Examples 25-27 can optionally include a wavelength of the reflected light being in the infrared spectrum.

In Example 30, the system of any one of or any combination of Examples 25-29 can optionally include an incident light having a spot size of about 1 mm by 1 mm.

In Example 31, the system of any one of or any combination of Examples 25-30 can optionally include the optical data including optical data for multiple locations on the surface of the sample.

in Example 32, the system of any one of or any combination of Examples 25-31 can optionally include the detector including Zn—Se based optics.

In Example 33, the system of any one of or any combination of Examples 25-32 can optionally include the signature of the reflected light including an intensity of the reflected light.

In Example 34, the system of any one of or any combination of Examples 25-32 can optionally include the signature of the reflected light including an irradiance of the reflected light.

In Example 35, the system of any one of or any combination of Examples 25-34 can optionally include the deviation including a contrast between a first image generated using the optical data and a second image generated using the calibrated data,

In Example 36, the system of any one of or any combination of Examples 25-35 can optionally include means for moving the sample when the reflected light is received at the detector.

Example 37 can include a machine-readable medium. The computer-readable medium can include instructions that, when executed by a processor, cause the processor to perform operations. The operations can comprise: receiving optical data from a detector, receiving calibrated data, and determining an existence of a void in a photoresist layer of a sample. The optical data can include information regarding a signature of the reflected light. The calibrated data can include information regarding a signature for a known sample of photoresist. The determination of the void can be based on a deviation of the optical data from the calibrated data.

In Example 38, the machine-readable medium of Example 37 can optionally include the optical data including optical data for multiple locations on the surface of the sample.

In Example 39, the machine-readable medium of any one of or any combination of Examples 37 and 38 can optionally include the signature of the reflected light including an intensity of the reflected light.

In Example 40, the machine-readable medium of any one of or any combination of Examples 37 and 38 can optionally include the signature of the reflected light including an irradiance of the reflected light.

In Example 41, the machine-readable medium of any one of or any combination of Examples 37-40 can optionally include the deviation including a contrast between a first image generated using the optical data and a second image generated using the calibrated data.

The above detailed description includes references to the accompanying drawings, which form a part of the detailed description. The drawings show, by way of illustration, specific embodiments that may be practiced. These embodiments are also referred to herein as “examples,” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof,or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “13 but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

Claimed is:

1. A system for detecting a void in a photoresist layer, the system comprising:
a detector arranged to receive reflected light from a surface of a sample;
a processor in electrical communication with the detector; and
a memory that stores instructions that, when executed by the processor, cause the processor to perform operations comprising:
receiving optical data from the detector, the optical data including information regarding a signature of the reflected light_{;}
receiving calibrated data, the calibrated data including information regarding a signature for a known sample of photoresist, and
determining an existence of the void based on a deviation of the optical data from the calibrated data,

2. The system of claim 1, further comprising a light source arranged to direct an incident light onto the surface of the sample.

3. The system of claim 2, wherein the light source includes a tunable laser.

4. The system of claim 1, wherein a wavelength of the reflected light is between about 1 μm and about 20 μm.

5. The system of claim 1, wherein a wavelength of the reflected light is in the infrared spectrum.

6. The system of claim 1, wherein an incident light has a spot size of about 1 mm by 1 mm.

7. The system of claim 1, wherein the optical data includes optical data for multiple locations on the surface of the sample.

8. The system of claim 1, wherein the detector includes Zn—Se based optics.

9. The system of claim 1, wherein the signature of the reflected light includes an intensity of the reflected light.

10. The system of claim 1, wherein the signature of the reflected light includes an irradiance of the reflected light.

11. The system of claim 1, wherein the deviation includes a contrast between a first image generated using the optical data and a second image generated using the calibrated data.

12. The system of claim 1, wherein the sample is in motion when the reflected light is received at the detector.

13. A method for detecting a void in a photoresist layer, the method comprising:
receiving optical data from a detector, the optical data including information regarding a signature of reflected light;
receiving calibrated data, the calibrated data including information regarding a signature for a known sample of photoresist; and
determining an existence of the void based on a deviation of the optical data from the calibrated data.

14. The method of claim 13, wherein the optical data includes optical data for multiple locations on a surface of the sample.

15. The method of claim 13, wherein the signature of the reflected light includes an intensity of the reflected light.

16. The method of claim 13, wherein the signature of the reflected light includes an irradiance of the reflected light.

17. A system for detecting a void in a photoresist layer, the system comprising:
means for receiving optical data from a detector, the optical data including information regarding a signature of reflected light;
means for receiving calibrated data, the calibrated data including information regarding a signature for a known sample of photoresist; and
means for determining an existence of the void based on a deviation of the optical data from the calibrated data.

18. The system of claim 17, farther comprising means for directing an incident light onto a surface of the sample.

19. The system of claim 17, wherein a wavelength of the reflected light is between about 1 and about 20 μm.

20. The system of claim 17, wherein an incident light has a spot size of about 1 mm by 1 mm.

21. The system of claim 17, wherein the optical data includes optical data for multiple locations on a surface of the sample.

22. The system of claim 17, wherein the signature of the reflected light includes an intensity of the reflected light.

23. The system of claim 17, wherein the signature of the reflected light includes an irradiance of the reflected light.

24. The system of claim 17, further including means for moving the sample when the reflected light is received at a detector.
